(19) United States
(12) Patent Application Publication
(10) Pub. No.: US 2026/0054115 A1
(43) Pub. Date: Feb. 26, 2026

(54) ATTACHING ACCESSORIES TO FIREFIGHTING VEHICLES

(71) Applicant: Howe & Howe Inc., Waterboro, ME (US)

(72) Inventors: Michael J. Zagorianakos, Buxton, ME (US); Timothy Merlin Foley, Lyman, ME (US); Keith Boissonneault, Lyman, ME (US)

(21) Appl. No.: 18/810,945

(22) Filed: Aug. 21, 2024

(51) Int. Cl. A62C 27/00; B66D 1/28

(52) U.S. Cl. CPC A62C 27/00; B66D 1/28; B66D 2700/0183

(57) ABSTRACT

A firefighting vehicle includes a firefighting vehicle body constructed and arranged to perform firefighting operations, a vehicle receiver coupled with the firefighting vehicle body, and a vehicle accessory which includes equipment constructed and arranged to operate while attached to firefighting vehicle body, and an attachment assembly constructed and arranged to attach the equipment to the firefighting vehicle body. The attachment assembly includes a base constructed and arranged to support the equipment and an insert coupled with the base. The insert is constructed and arranged to engage with the vehicle receiver. The attachment assembly further includes an auxiliary receiver coupled with the base. The auxiliary receiver is constructed and arranged to engage with an insert of an auxiliary accessory that is different from the vehicle accessory.

### BACKGROUND

Firefighting robotic vehicles have been used in dangerous situations to assist human firefighters in extinguishing and preventing the spread of fires. Such robots can enter hot, smoke-filled areas, even when open flames are present, and can direct large amounts of water at burning objects at very high speed.

Such a firefighting robotic vehicle may be equipped with an accessory. For example, the firefighting robotic vehicle may have a receiver enabling attachment of the accessory.

### SUMMARY

Sometimes, it may be desirable to attach an accessory to a firefighting robotic vehicle. Along these lines, the accessory may enhance or augment operation of the firefighting robotic vehicle.

One example of an accessory is a winch having a tube which installs into a receiver of the firefighting robotic vehicle. Once the tube of the winch is installed into the receiver, the winch is able to pull (or tow) objects from behind the firefighting robotic vehicle.

Another example of an accessory is a hose manager having a tube which installs into the receiver of the firefighting robotic vehicle. Once the tube of the hose manager is installed into the receiver, the hose manager is able to guide connected hoses away from the lower rear of the firefighting robotic vehicle (e.g., to prevent the firefighting robotic vehicle from inadvertently running over and/or damaging the hoses).

Unfortunately, installing one accessory onto the firefighting robotic vehicle prevents another accessory from being installed. For example, once the winch is installed onto the firefighting robotic vehicle, the receiver is now occupied and the hose manager cannot be installed. Moreover, such firefighting robotic vehicles are typically densely populated with componentry, gear, apparatus, etc. such that there is little to no extra space available for attaching another accessory. What is needed, therefore, is a way of attaching multiple accessories to a firefighting robotic vehicle in a manner that consumes little to no extra space.

The above need is addressed at least in part by an improved technique for attaching accessories to a firefighting vehicle. The technique involves attaching, to a vehicle receiver of the firefighting vehicle, a vehicle accessory which has an auxiliary receiver. With the auxiliary receiver, yet another accessory may be attached to the firefighting vehicle. In some arrangements, the vehicle accessory is a winch attachment onto which an auxiliary accessory attaches (e.g., a hose manager, a platform or shelf, an electronic device, combinations thereof, etc.). Accordingly, multiple accessories may be attached to a firefighting robotic vehicle in a manner that consumes little to no extra space.

One embodiment is directed to a vehicle accessory which includes equipment constructed and arranged to operate while attached to a vehicle, and an attachment assembly constructed and arranged to attach the equipment to the vehicle. The attachment assembly has a base constructed and arranged to support the equipment. The attachment assembly further has an insert coupled with the base, the insert being constructed and arranged to engage with a vehicle receiver of the vehicle. The attachment assembly further has an auxiliary receiver coupled with the base, the auxiliary receiver being constructed and arranged to engage with an insert of an auxiliary accessory that is different from the vehicle accessory.

Another embodiment is directed to a firefighting vehicle which includes a firefighting vehicle body constructed and arranged to perform firefighting operations.

The firefighting vehicle further includes a vehicle receiver coupled with the firefighting vehicle body. The firefighting vehicle further includes a vehicle accessory which includes (i) equipment constructed and arranged to operate while attached to firefighting vehicle body, and (ii) an attachment assembly constructed and arranged to attach the equipment to the firefighting vehicle body. The attachment assembly includes:
(A) a base constructed and arranged to support the equipment,
(B) an insert coupled with the base, the insert being constructed and arranged to engage with the vehicle receiver, and
(C) an auxiliary receiver coupled with the base, the auxiliary receiver being constructed and arranged to engage with an insert of an auxiliary accessory that is different from the vehicle accessory.

In some arrangements, the equipment of the vehicle accessory includes a winch device coupled with the base of the attachment assembly, the winch device being constructed and arranged to pull loads relative to the firefighting vehicle body when the winch device is attached to the firefighting vehicle body via the attachment assembly.

In some arrangements, the winch device includes a spool, a cable wound at least partly around the spool, and a motor supported by the base of the attachment assembly. The motor is constructed and arranged to turn the spool to control winding of the cable around the spool.

In some arrangements, the base of the attachment assembly includes a plate constructed and arranged to provide a horizontal platform that supports the winch device when the insert of the attachment assembly is inserted into the vehicle receiver.

In some arrangements, the insert of the attachment assembly defines an insert axis along which the insert engages the vehicle receiver. Additionally, the auxiliary receiver defines an auxiliary receiver axis along which the auxiliary receiver receives the insert of the auxiliary accessory, the auxiliary receiver axis being parallel to the insert axis defined by the insert of the attachment assembly.

In some arrangements, the motor of the winch device has an axis of rotation that is perpendicular to the insert axis defined by the insert of the attachment assembly.

In some arrangements, the winch device further includes a cable guide that defines an opening through which the cable passes, the cable guide being disposed above the auxiliary receiver of the attachment assembly.

In some arrangements, the base of the attachment assembly includes a plate constructed and arranged to provide a horizontal platform to support the equipment. Additionally, at least a portion of the insert of the attachment assembly is disposed on a first side of the plate. Furthermore, at least a portion of the auxiliary receiver is disposed on a second side of the plate that is opposite the first side of the plate.

In some arrangements, at least a portion of the insert of the attachment assembly is disposed on a top side of the plate. Additionally, at least a portion of the auxiliary receiver is disposed on a bottom side of the plate.

In some arrangements, the attachment assembly further includes a set of gussets coupled with the plate and with the auxiliary receiver. The set of gussets provides strength to support loading perpendicular to the plate and axial loading from the auxiliary receiver.

In some arrangements, the set of gussets includes:
(i) a left V-shaped gusset welded to the bottom side of the plate and to a left side of the auxiliary receiver, and
(ii) a right V-shaped gusset welded to the bottom side of the plate and to a right side of the auxiliary receiver.

In some arrangements, a back side of the firefighting vehicle body includes a set of hose couplings constructed and arranged to couple with a set of hoses. Additionally, the vehicle receiver is disposed on the back side adjacent to the set of hose couplings.

In some arrangements, the equipment of the vehicle accessory includes a winch device coupled with the base of the attachment assembly. The winch device is constructed and arranged to pull loads from a location adjacent the set of hose couplings when the winch device is attached to the firefighting vehicle body via the attachment assembly.

In some arrangements, the auxiliary accessory is a hose manager which includes:
(i) a hose manager insert constructed and arranged to engage with the auxiliary receiver, and
(ii) an elongated section coupled with the hose manager insert, the elongated section defining a hose deflection surface to manage a set of hoses when the set of hoses couples with the set of hose couplings.

In some arrangements, the hose manager insert and the insert of the attachment assembly have a common form factor which enables the hose manager insert to engage with the vehicle receiver.

In some arrangements, the firefighting vehicle further includes:
(i) a robotically controlled propulsion system coupled with the firefighting vehicle body, and
(ii) a set of tracks driven by the robotically controlled propulsion system to form a firefighting robotic vehicle.

Other embodiments are directed to systems, sub-systems, apparatus, assemblies, componentry, and so on. Some embodiments are directed to various methods, devices, platforms, etc. which are involved in attaching vehicle accessories to a firefighting vehicle.

This Summary is provided merely for purposes of summarizing some example embodiments so as to provide a basic understanding of some aspects of the disclosure.

Accordingly, it will be appreciated that the above described example embodiments are merely examples and should not be construed to narrow the scope or spirit of the disclosure in any way. Other embodiments, aspects, and advantages will become apparent from the following detailed description taken in conjunction with the accompanying drawings which illustrate, by way of example, the principles of the described embodiments.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a perspective view of a firefighting robotic vehicle which includes an example vehicle accessory having an auxiliary receiver in accordance with certain embodiments.

FIG. 2 is another perspective view of the firefighting robotic vehicle in accordance with certain embodiments.

FIG. 3 is a perspective view of a portion of the firefighting robotic vehicle in accordance with certain embodiments.

FIG. 4 is another perspective view of a portion of the firefighting robotic vehicle in accordance with certain embodiments.

FIG. 5 is a perspective view showing the example vehicle accessory separated from the vehicle body of the firefighting robotic vehicle in accordance with certain embodiments.

FIG. 6 is a perspective view of the example vehicle accessory in accordance with certain embodiments.

FIG. 7 is another perspective view of the example vehicle accessory in accordance with certain embodiments.

FIG. 8 is a perspective view showing partial engagement of the example vehicle accessory in accordance with certain embodiments.

FIG. 9 is another perspective view showing full engagement of the example vehicle accessory in accordance with certain embodiments.

FIG. 10 is a perspective view of an attachment assembly of the example vehicle accessory in accordance with certain embodiments.

FIG. 11 is another perspective view of the attachment assembly of the example vehicle accessory in accordance with certain embodiments.

FIG. 12 is a perspective view showing the example vehicle accessory separated from the vehicle body of the firefighting robotic vehicle and an auxiliary accessory separated from the example vehicle accessory in accordance with certain embodiments.

FIG. 13 is a detailed perspective view showing the firefighting robotic vehicle, the example vehicle accessory, and the auxiliary accessory in accordance with certain embodiments.

### DETAILED DESCRIPTION

An improved technique is directed to attaching accessories to a firefighting vehicle. The technique involves attaching, to a vehicle receiver of the firefighting vehicle, a vehicle accessory which has an auxiliary receiver. With the auxiliary receiver, yet another accessory may be attached to the firefighting vehicle. In some arrangements, the vehicle accessory is a winch attachment onto which an auxiliary accessory attaches (e.g., a hose manager, a platform or shelf, an electronic device, combinations thereof, etc.). Accordingly, multiple accessories may be attached to a firefighting robotic vehicle in a manner that consumes little to no extra space.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

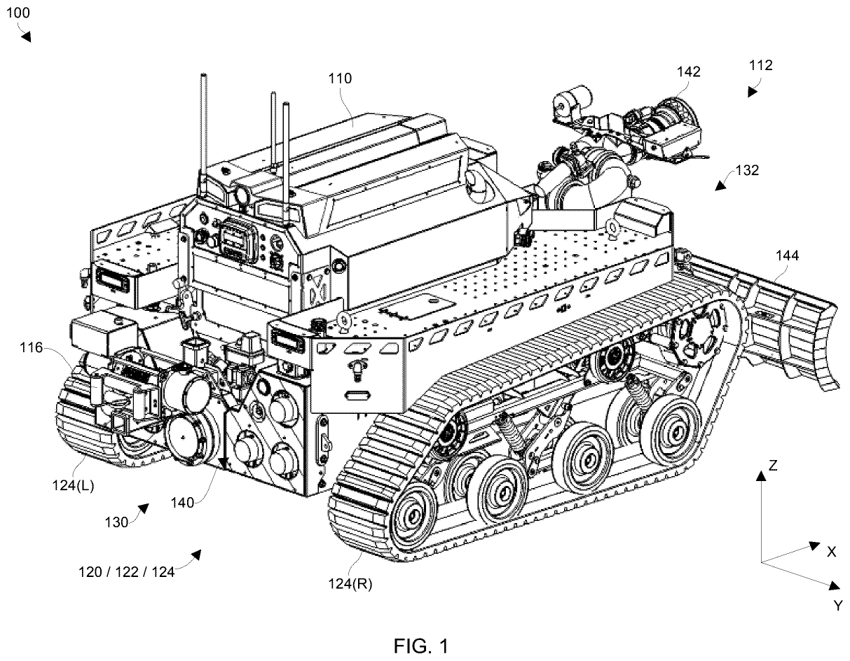

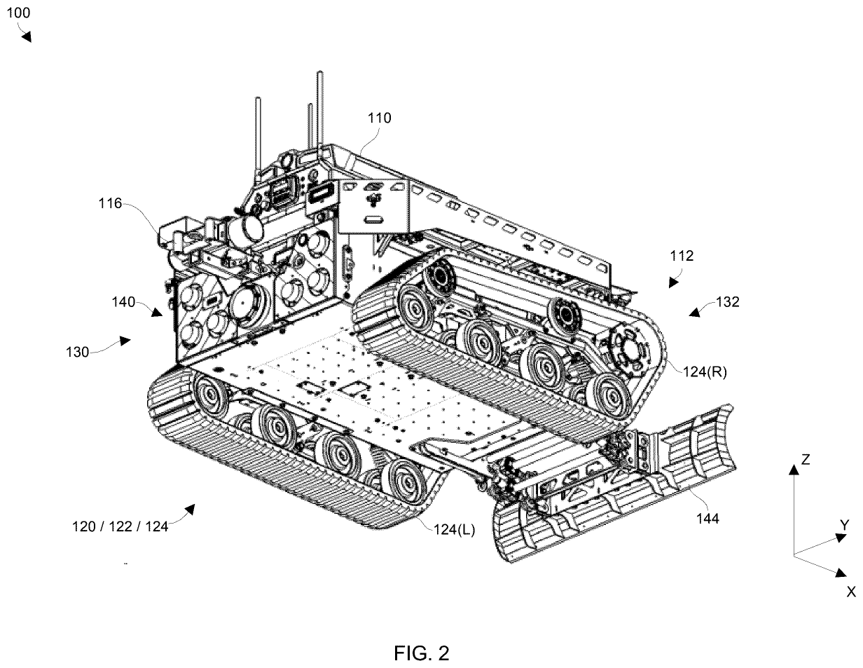

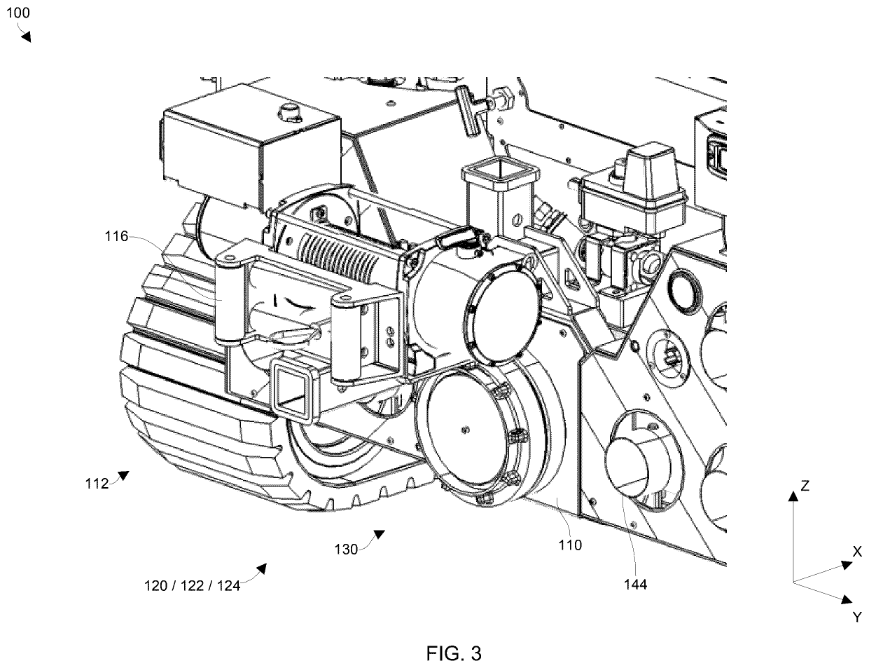

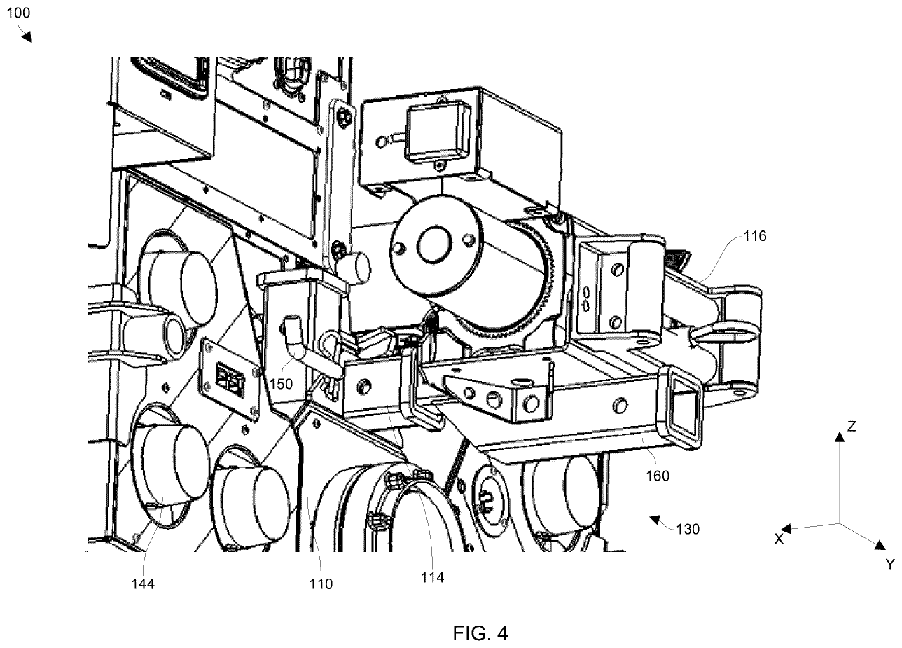

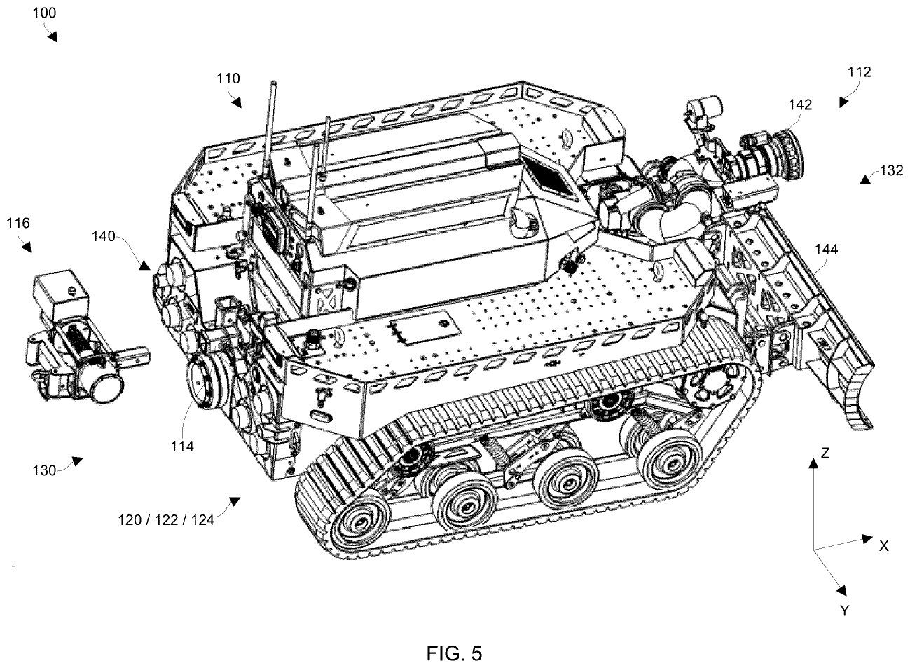

FIGS. 1 through 5 show a firefighting robotic vehicle 100 which includes an example vehicle accessory having an auxiliary receiver in accordance with certain embodiments. FIG. 1 is a perspective view of the firefighting robotic vehicle 100. FIG. 2 is another perspective view of the firefighting robotic vehicle 100. FIG. 3 is a perspective view of a portion of the firefighting robotic vehicle 100. FIG. 4 is another perspective view of a portion of the firefighting robotic vehicle 100. FIG. 5 is a perspective view showing the example vehicle accessory separated from a vehicle body of the firefighting robotic vehicle 100.

The firefighting robotic vehicle 100 is constructed and arranged to connect with a set of fluid sources (e.g., by connecting with one or more hoses leading to the set of fluid sources), move over a ground surface based on remote commands (e.g., in response to wireless signals from a base station), and deploy fluid from the set of fluid sources toward a target in response to remote commands (e.g., spray the fluid onto a burning structure). Such a firefighting robotic vehicle 100 has the ability to withstand environments that are too hazardous for human personnel.

As shown in FIGS. 1 through 5, the firefighting robotic vehicle 100 includes a firefighting vehicle body 110, firefighting equipment 112, a vehicle receiver 114, and a vehicle accessory 116.

The firefighting vehicle body 110 is constructed and arranged to perform a variety of operations. Along these lines, the vehicle body 110 supports a robotically controlled propulsion system 120 and a set of ground engaging members 122.

In response to remote commands, the robotically controlled propulsion system 120 drives the set of ground engaging members 122 to maneuver the firefighting robotic vehicle 100 over a ground surface. In some arrangements, the set of ground engaging members 122 includes a left track 124(L) and a right track 124(R) (collectively, tracks 124) which are driven by a set of wheels and motors (or engines) to enable the vehicle 100 to easily traverse a variety of different terrains which may be smooth, rough, hilly, uneven, irregular, etc. (e.g., roads, fields, sand, hills, ditches, rocky areas, uneven slopes, outcrops, creeks, marshes, combinations thereof, and so on).

The firefighting vehicle body 110 is further constructed and arranged to support the firefighting equipment 112. In some embodiments, the firefighting equipment 112 includes a set of fluid conduits, such as one or more pipes (e.g., a single conduit or multiple conduits which may be stacked vertically and/or arranged side-by-side), running from a rear 130 of the vehicle body 110 to a front 132 of the vehicle body 110.

The firefighting equipment 134 may further include a set of fluid couplings 140 at the rear 130 of the vehicle body 110 allowing for attachment of hoses or the like for delivering firefighting fluid, such as water, gel, or foam, to the set of conduits from an environment outside of the vehicle 100. Along these lines, the set of hoses may further attach to fluid sources such as hydrants, tanks, trucks or trailers, combinations thereof, etc.

Additionally, the firefighting equipment 112 may include a monitor 142 at the front 132 of the firefighting vehicle body 110 (e.g., see FIGS. 1 and 5). The monitor 142 receives the firefighting fluid conducted through the set of conduits 140 and emits the firefighting fluid toward desired locations in the environment.

Furthermore, the firefighting equipment 112 may include other apparatus such as a frontend head attachment 144 disposed at the front 132 of the firefighting vehicle body 110. By way of example, the frontend head attachment 144 includes a plow for pushing, separating, spreading materials, etc. However, other apparatus are suitable for the frontend head attachment 144 (e.g., a forklift, a forklift/plow combination, and so on).

It should be understood that the firefighting vehicle body 110 and/or the firefighting equipment 112 may provide certain other features such as a deck section which serves as a platform for performing various operations such as supporting specialized sensing equipment, carrying a tank that holds foam concentrate (e.g., for mixing with water before spraying), supporting a fan, supporting an array of lights and/or other equipment, carrying cargo, combinations thereof, etc.

As best seen in FIGS. 4 and 5, the vehicle receiver 114 resides on the rear 130 of the firefighting vehicle body 110 to enable installation and support of the vehicle accessory 116. However, due to limited space and/or the possibility of interfering with various equipment, it may be difficult to place another vehicle receiver 114 on the rear 130 of the firefighting vehicle body 110.

Attachment of the vehicle accessory 116 involves inserting an insert (or tube) of the vehicle accessory 116 into the vehicle receiver 114 in the positive X-direction.

Removal of the vehicle accessory 116 involves sliding the insert of the vehicle accessory 116 out of the vehicle receiver 114 in the negative X-direction.

In some embodiments, the vehicle receiver 114 is an elongated shaft which is sized, gauged, etc. to support a variety of vehicle accessories 116. Along these lines, the vehicle receiver 114 may be a pipe (or conduit) constructed and arranged to receive the insert of the vehicle accessory 116. In some arrangements, the vehicle receiver 114 has a square cross-section (e.g., 1.5″×1.5″, 2.0″×2.0″, 2.5″×2.5″, etc.) to receive the insert (e.g., an elongated solid member having a square cross-section).

Retaining the vehicle accessory 116 to the firefighting vehicle body 110 may involve installing a pin 150 through both the vehicle receiver 114 and the insert of the vehicle accessory 116 (e.g., an L-shaped bolt). While the pin 150 is in place, the insert of the vehicle accessory 116 and the vehicle receiver 114 are locked (or held) together.

Additionally, the pin 150 is removed to unlock (or release) the vehicle accessory 116 from the vehicle receiver 114.

In some embodiments, the vehicle receiver 114 the pin 150 may be held in place by a cotter pin (e.g., which slides through a bore in the pin 150 at the end opposite to end which bends to form the L) to richly and reliably retain the vehicle accessory 116 (e.g., see FIG. 4). Nevertheless, the vehicle accessory 116 may be removed, reinstalled, replaced, etc. by simply removing the cotter pin and then removing the pin 150 from the vehicle receiver 114.

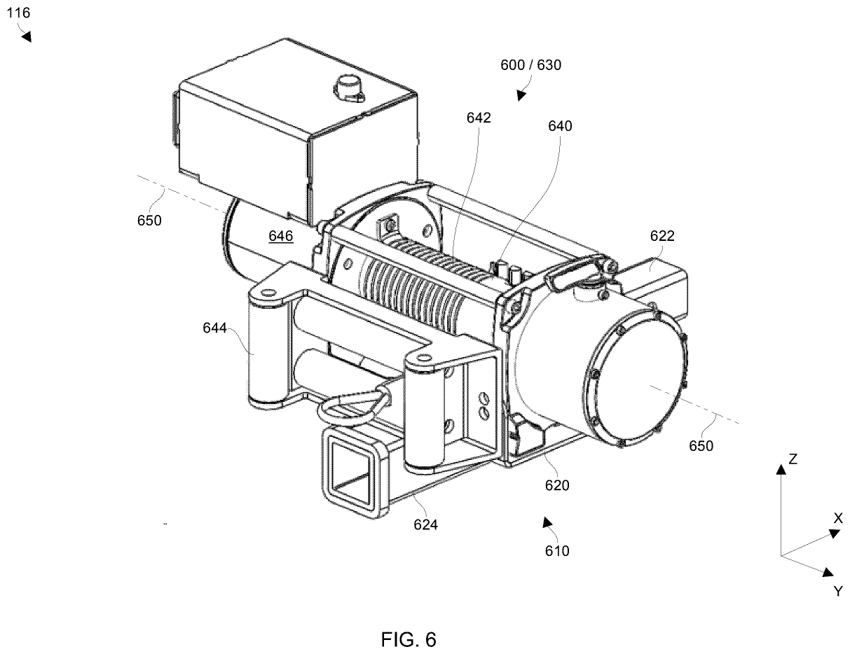

As will be explained in further detail shortly, the vehicle accessory 116 includes an auxiliary receiver 160 which enables an auxiliary accessory to further attach to the vehicle body 110 (e.g., see FIG. 4). In some arrangements, the auxiliary receiver 160 has the same geometry as that of the vehicle receiver 114 and is therefore capable of receiving and retaining an auxiliary accessory. Such a feature enables multiple accessories to attach to the vehicle body 110 without consuming additional space on the vehicle body 110. Further details will now be provided with reference to FIGS. 6 through 9.

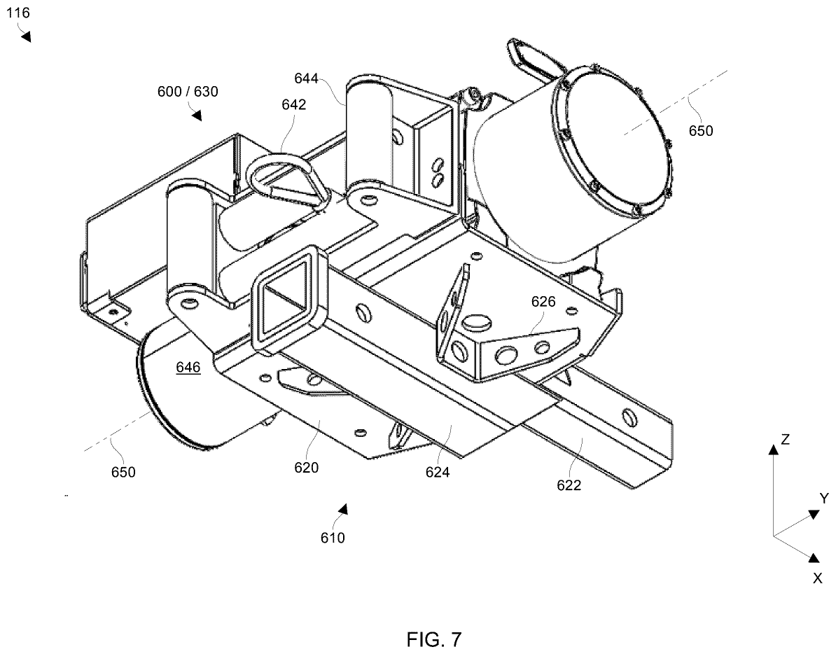

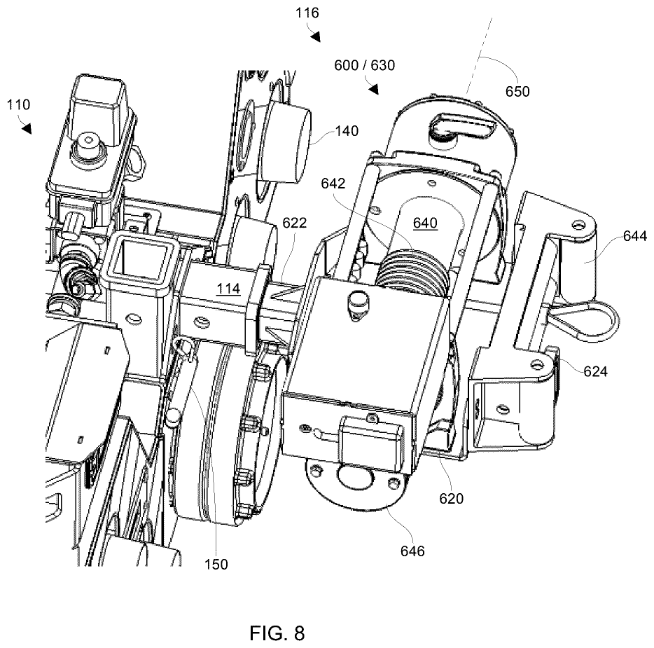

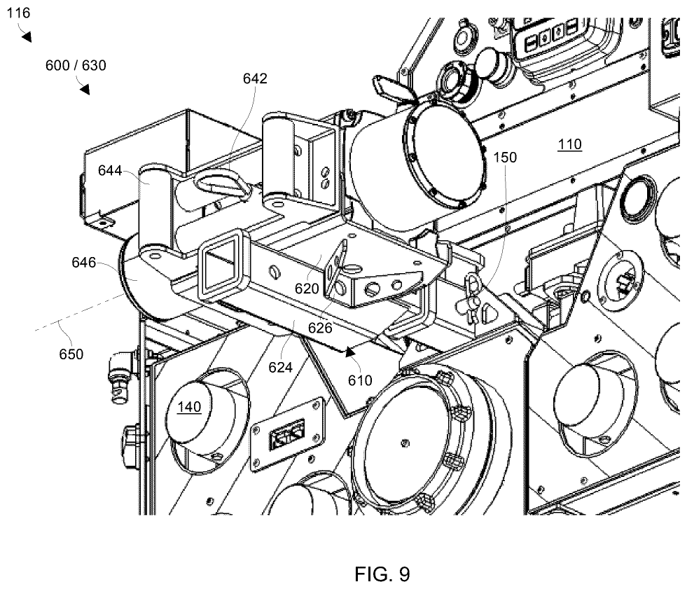

FIGS. 6 through 9 shows details of the example vehicle accessory 116 in accordance with certain embodiments. FIG. 6 is a perspective view of the example vehicle accessory 116. FIG. 7 is another perspective view of the example vehicle accessory 116. FIG. 8 is a perspective view showing partial engagement of the example vehicle accessory 116 with the vehicle receiver 114. FIG. 9 is another perspective view showing full engagement of the example vehicle accessory 116 with the vehicle receiver 114.

The example vehicle accessory 116 is a winch attachment which enables the firefighting robotic vehicle 100 to pull (or tow) objects from the rear 130 (also see FIGS. 1, 2 and 5). The vehicle accessory 116 includes equipment 600 and an attachment assembly 610.

The equipment 600 is constructed and arranged to operate while attached to firefighting vehicle body 110. Such equipment 600 enhances and/or augments operation of the firefighting robotic vehicle 100 (also see FIGS. 1 and 2). Along these lines, the firefighting robotic vehicle 100 is then able to pull or tow objects from the rear 130 (FIGS. 1 and 2).

The attachment assembly 610 is constructed and arranged to attach the equipment 600 to the firefighting vehicle body 110. As will be explained in further detail shortly, the attachment assembly 610 is further constructed and arranged to enable an auxiliary accessory to attach to the firefighting robotic vehicle 100. However, the auxiliary accessory attaches to the vehicle 100 indirectly through the vehicle accessory 116 thus alleviating the need to consume more space on the rear 130 of the vehicle 100.

As shown in FIGS. 6 and 7, the attachment assembly 610 includes a base 620, an insert (or tube) 622, an auxiliary receiver 624, and a set of gussets 626. The base 620 is constructed and arranged to support the equipment 600. The insert 622 couples with the base 620 and is constructed and arranged to engage with the vehicle receiver 114 (also see FIG. 4). The auxiliary receiver 624 couples with the base 620 and is constructed and arranged to engage with an insert of an auxiliary accessory that is different from the vehicle accessory 116. The set of gussets 626 provides strength to the attachment assembly 610.

In this example, the equipment 600 includes a winch device 630 which, when attached to the firefighting robotic vehicle 100, enables the vehicle 100 to pull, tow, etc. loads relative to the firefighting vehicle body 110. Along these lines, the winch device 630 attaches to a location adjacent the set of hose couplings 140 and is able to operate from that location (FIGS. 1 and 2). In such arrangements, operation of the equipment 600 avoids interference with any hoses that connect to lower and/or lateral hose couplings 140.

The winch device 630 includes a spool 640, a cable 642, a cable guide 644, and a motor 646. The spool 640 has an axis of rotation 650 which extends along the Y-axis and which is parallel to the rear 130 of the vehicle body 110 (i.e., the Y-Z plane) and perpendicular to axis defined by the insert 622 and the vehicle receiver 624 for installation/removal (i.e., the X-axis). The cable 642 winds at least partly around the spool 640. Additionally, the cable guide 644 defines an opening through which the cable 642 passes. Furthermore, the motor 644 is supported by the base 620 of the attachment assembly 610 and is constructed and arranged to turn the spool 640 to control winding/unwinding of the cable 642 relative to the spool 640 through the cable guide 644. Accordingly, the winch device 630 is able to draw and/or tow objects behind the vehicle body 110.

In some arrangements, the cable guide 644 is disposed above the auxiliary receiver 624 of the attachment assembly 610. Accordingly, the cable 642 extends from the vehicle 100 from a location that is above the auxiliary accessory attachment point to avoid interference.

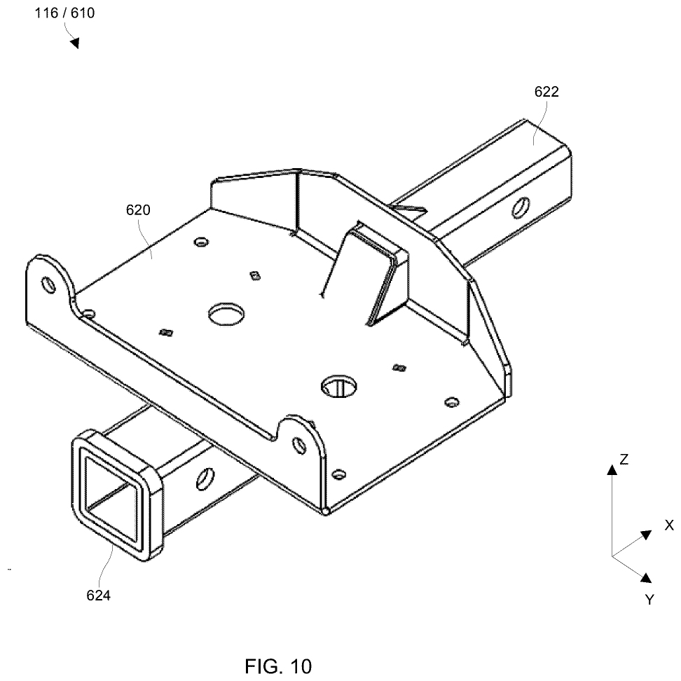

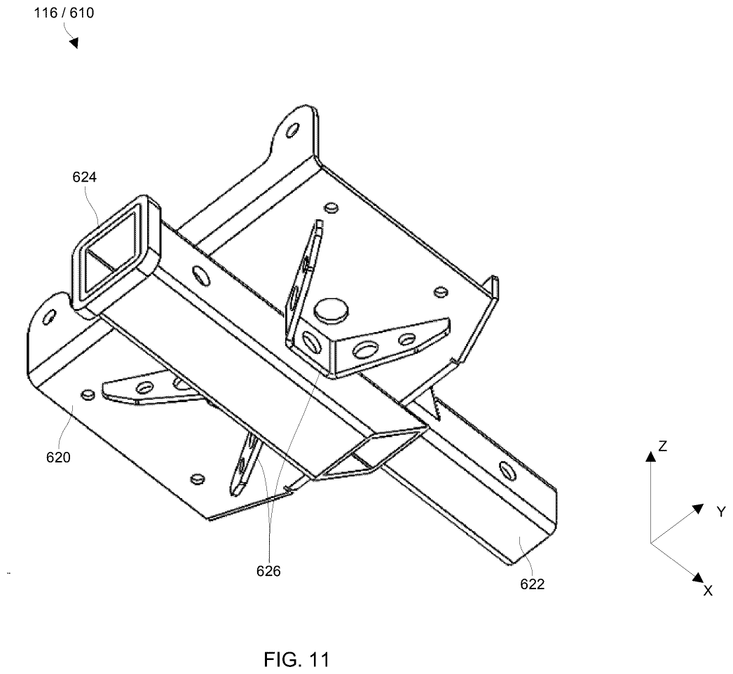

It should be appreciated that it may make sense to attach another accessory to the vehicle 100 while the vehicle 100 is operating in the field. However, rather than detach the vehicle accessory 116 (e.g., by removing the pin 150 to unlock the insert 622 from the vehicle receiver 114), the other accessory may be attached to the vehicle 100 by simply utilizing the auxiliary receiver 624 of the vehicle accessory 116. Accordingly, the vehicle 100 does not lose the abilities provided by the vehicle accessory 116, and extra time and effort is not wasted in removing the vehicle accessory 116. Further details will now be provided with reference to FIGS. 10 and 11.

FIGS. 10 and 11 show certain details of the attachment assembly 610 of the vehicle accessory 116. FIG. 10 is a perspective view of the attachment assembly 610 from an elevated angle. FIG. 11 is a perspective view of the attachment assembly 610 from a lower angle. As mentioned earlier in connection with FIGS. 6 through 9, the attachment assembly includes a base 620, an insert 622, an auxiliary receiver 624, and a set of gussets 626.

The base 620 includes a plate which extends in the X-Y plane to serve as a horizontal platform that supports the equipment 600 off the rear 130 of the vehicle body 110 (FIGS. 6 through 9). In some arrangements, the base 620 further includes or defines various features such as mounting holes to enable hardware to fasten the equipment 600 to the base 620, flanges which may extend in a direction that is perpendicular to the X-Y plane to properly support and/or position the equipment on the base 620, welds/ribs/bends for added strength, and so on.

It should be understood that the particular form factor of the base 620 may be specific to the particular equipment 600 that is supported by the base 620. Along these lines, the plate of the base 620 is generally rectangular to accommodate the rectangular footprint of the winch device 630 (FIGS. 6 and 7). For other types of equipment 600, the base 620 may have other shapes (e.g., elongated, arc-shaped, irregular, narrow, upright, combinations thereof, etc.).

The insert 622 couples with base 620 and extends along the X-axis for insertion into the vehicle receiver 114 (FIGS. 4 and 5). Lateral holes through the insert 622 enable locking of the insert 622 with the vehicle receiver 114 (e.g., via a pin 150).

In some arrangements, at least a portion of the insert 622 is welded to the base 620 for added attachment strength. In some arrangements, at least part of the insert 622 is integrated with the base 620 (e.g., a portion of the base 620 is bent upward to form a back end of the insert 622). In some arrangements, a flanged portion of the base 620 which extends in the Y-Z plane retains an end portion of the insert 622 with the base 620 for additional attachment strength (FIG. 10). Other features (additional flanges, welds, ribs, etc.) may exist to further strengthen attachment of the insert 622 with the base 620.

The auxiliary receiver 624 couples with base 620 and extends along the X-axis to enable attachment of an auxiliary accessory to the vehicle accessory 116. Lateral holes through the auxiliary receiver 624 enable locking of the auxiliary receiver 624 with an insert of the auxiliary receiver (e.g., via a pin).

With the insert 622 and the auxiliary receiver 624 being parallel with each other along the X-axis (e.g., with the insert 622 being mounted to a top side of the base plate and the auxiliary receiver 624 being mounted to a bottom side of the base plate), the auxiliary receiver 624 is able to attach in the same orientation to the vehicle body 110 when attached to the vehicle accessory 116 as the auxiliary receiver 624 would be if directly attached to the vehicle receiver 114. In some arrangements, the auxiliary receiver 624 is mounted underneath the base 620 to enable positioning of an attached auxiliary accessory at substantially the same height and/or location as the vehicle accessory 116 relative to the vehicle body 110. In some arrangements, an end of the insert 622 overlaps with an end of the auxiliary receiver 624 to maximize insert and receiver lengths for strength purposes.

The set of gussets 626 (e.g., see FIG. 11) provides strength to the base 620 to support the equipment 600 as well as to strengthen attachment of the auxiliary receiver 624 to the base 620. Along these lines, the set of gussets 626 provides strength to support loading perpendicular to the base plate and axial loading from the auxiliary receiver 624.

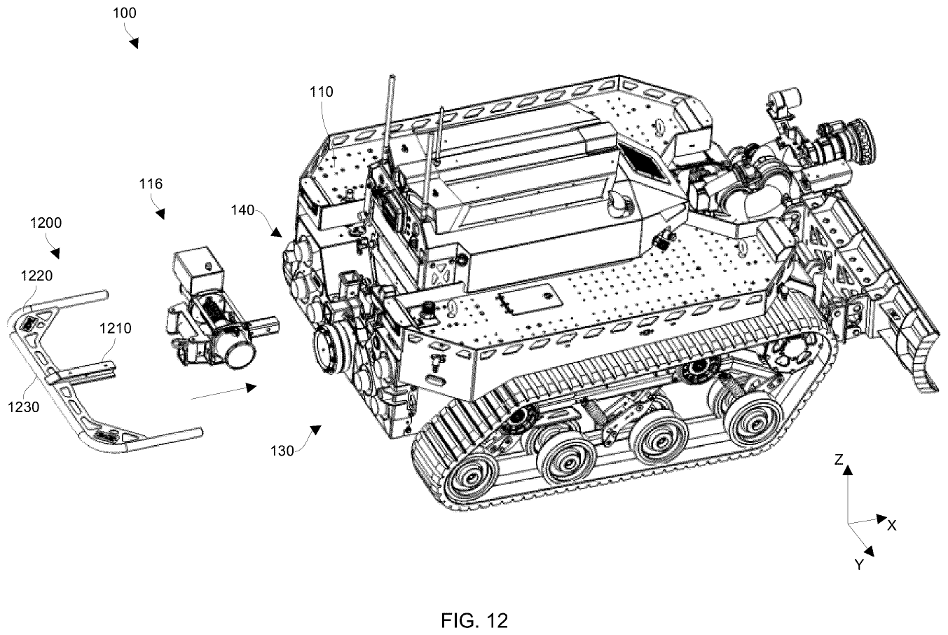

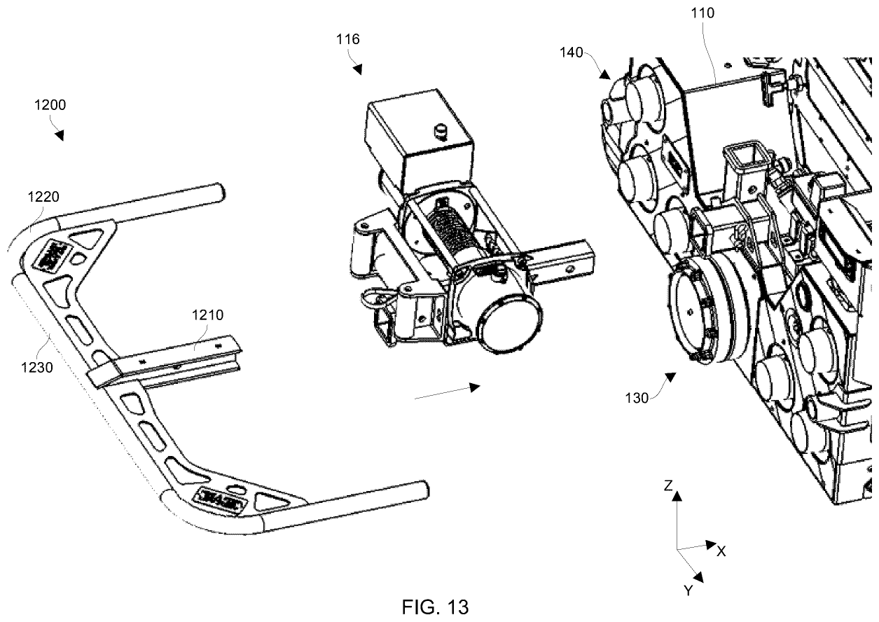

In some arrangements, the set of gussets 626 includes a left V-shaped gusset 626 welded to the bottom side of the base plate and to a left side of the auxiliary receiver 624, and a right V-shaped gusset 626 welded to the bottom side of the base plate and to a right side of the auxiliary receiver 626. In some arrangements, the set of gussets 626 define holes for strength, weight control, etc. Further details will now be provided with reference to FIGS. 12 and 13.

FIGS. 12 and 13 show how the firefighting robotic vehicle 100 utilizes multiple accessories 116, 1200. FIG. 12 is a system view. FIG. 13 is a detailed view.

As shown in FIGS. 12 and 13, the multiple accessories 116, 1200 may be attached to the rear 130 of the vehicle body 110 in a manner that consumes little to no extra space. That is, the vehicle accessory 116 attaches directly to the vehicle body 110 via the vehicle receiver 114 (also see FIGS. 1 and 2). Additionally, the auxiliary accessory 1200 attaches indirectly to the vehicle body 110 via the vehicle accessory 116.

By way of example, the auxiliary accessory 1200 is a hose manager which manages hoses which may connect to the rear 130 of the vehicle 100. Such a hose manager includes an auxiliary insert 1210 and an elongated section 1220 (e.g., a lateral structure). The auxiliary insert 1210 of the hose manager is constructed and arranged to engage a receiver such as either the auxiliary receiver 626 of the vehicle accessory 116 or the vehicle receiver 114 on the rear 130 of the vehicle body 110 when the vehicle receiver 114 is not present.

The elongated section 1220 couples with the hose manager insert 1210. In some arrangements, the elongated section 1220 includes braces, scaffolding, flanges, tabs, welds, combinations thereof, etc. for additional support/strength. The elongated section 1220 defines a hose deflection surface 1230 to manage a set of hoses when the set of hoses couples with the set of hose couplings 140.

It should be understood that other types of accessories are suitable for attaching to the vehicle accessory 116. Along these lines, any accessory that is able to attach to the vehicle receiver 114 on the rear 130 of the vehicle body 110 may alternatively attach to the auxiliary receiver 626 of the vehicle accessory 116. As a result, multiple accessories 116, 1200 may be attached in a manner that consumes little to no extra space on the rear 130 of the vehicle body 110. Moreover, the auxiliary accessory 1200 may be provisioned with an auxiliary receiver in a similar manner.

As described above, improved techniques are directed to attaching, to a vehicle receiver 116 of the firefighting vehicle 100, a vehicle accessory 116 which has an auxiliary receiver 626. With the auxiliary receiver 626, yet another accessory 1200 may be attached to the firefighting vehicle 100. In some arrangements, the vehicle accessory 116 is a winch attachment onto which an auxiliary accessory 1200 attaches (e.g., a hose manager, a platform or shelf, an electronic device, combinations thereof, etc.). Accordingly, multiple accessories 116, 1200 may be attached to a firefighting robotic vehicle 100 in a manner that consumes little to no extra space.

It should be appreciated that, in the general field of receiver hitch implements and specifically with regard to firefighting robots, there is a need to attach accessories in a manner that minimizes consumed space.

Along these lines, a typical winch mount uses the vehicles standard receiver when installed meaning the user will have to remove it if the user wishes to use any other attachment that uses the same receiver. Unfortunately, this is because conventional winch mounts serve one purpose and that is to hold the winch.

However, suppose that the user needs to use a ball hitch (or whatever type of implement desired) instead of the winch mount. Conventionally, the best way to accomplish something like this would have been to remove the winch mount from the hitch receiver on the vehicle and then install a ball hitch. In this situation, since the winch mount uses the receiver tube, you would have to uninstall the winch mount from the vehicle and store it somewhere to be able to use the receiver for any other purpose.

In accordance with certain embodiments, there is no need to remove a winch accessory. Rather, the winch accessory is itself provisioned with a hitch receiver. Accordingly, the user can instead use the receiver that is on the winch accessory. This allows the user to have a winch installed and have an open receiver at the same time.

In some embodiments, a 2-inch receiver tube is welded it to the bottom of a winch mount. Such a winch mount may have a tube that goes into the 2-inch standard receiver of any vehicle and then has a plate welded to the tube. That plate is where both the winch device itself is mounted. The 2-inch receiver tube is then welded underneath the plate so that the winch mount provides an available 2-inch receiver.

In accordance with certain embodiments disclosed herein, a user is able to leave the winch installed and have an open receiver that can be used. Such ability is unavailable with conventional winch mounts which use the vehicle's standard receiver (i.e., the user must remove the conventional winch mount to use another attachment that uses the same receiver).

As disclosed herein, a user can install a winch and have an open receiver at the same time. Such improvements can be used on any vehicle that uses a winch mount so that the user can have the winch installed and still have the ability to attach another accessory.

Such improvements are suitable for use in almost any industry that has a vehicle with a receiver hitch and also utilizes a winch. This can range from not only firefighting and emergency vehicles but also off road, rescue/recovery, towing, industrial, agricultural vehicles to name a few. Really any vehicle that has a hitch and needs to utilize a winch. Moreover, the features can easily be modified for any size winch and receiver hitch (smaller, larger, upgrade in receiver size where the receiver diameters are different sizes, downgrade in receiver size where the receiver diameters are different sizes, etc.).

While various embodiments of the present disclosure have been particularly shown and described, it will be understood by those skilled in the art that various changes in form and details may be made therein without departing from the spirit and scope of the present disclosure as defined by the appended claims. Such modifications and enhancements are intended to belong to various embodiments of the disclosure.

What is claimed is:

1. A firefighting vehicle, comprising:
a firefighting vehicle body constructed and arranged to perform firefighting operations;
a vehicle receiver coupled with the firefighting vehicle body; and
a vehicle accessory which includes (i) equipment constructed and arranged to operate while attached to firefighting vehicle body, and (ii) an attachment assembly constructed and arranged to attach the equipment to the firefighting vehicle body, the attachment assembly including:
a base constructed and arranged to support the equipment,
an insert coupled with the base, the insert being constructed and arranged to engage with the vehicle receiver, and
an auxiliary receiver coupled with the base, the auxiliary receiver being constructed and arranged to engage with an insert of an auxiliary accessory that is different from the vehicle accessory.

2. The firefighting vehicle of claim 1 wherein the equipment of the vehicle accessory includes:
a winch device coupled with the base of the attachment assembly, the winch device being constructed and arranged to pull loads relative to the firefighting vehicle body when the winch device is attached to the firefighting vehicle body via the attachment assembly.

3. The firefighting vehicle of claim 2 wherein the winch device includes:
a spool,
a cable wound at least partly around the spool, and
a motor supported by the base of the attachment assembly, the motor being constructed and arranged to turn the spool to control winding of the cable around the spool.

4. The firefighting vehicle of claim 3 wherein the base of the attachment assembly includes:
a plate constructed and arranged to provide a horizontal platform that supports the winch device when the insert of the attachment assembly is inserted into the vehicle receiver.

5. The firefighting vehicle of claim 4 wherein the insert of the attachment assembly defines an insert axis along which the insert engages the vehicle receiver; and
wherein the auxiliary receiver defines an auxiliary receiver axis along which the auxiliary receiver receives the insert of the auxiliary accessory, the auxiliary receiver axis being parallel to the insert axis defined by the insert of the attachment assembly.

6. The firefighting vehicle of claim 5 wherein the motor of the winch device has an axis of rotation that is perpendicular to the insert axis defined by the insert of the attachment assembly.

7. The firefighting vehicle of claim 6 wherein the winch device further includes:
a cable guide that defines an opening through which the cable passes, the cable guide being disposed above the auxiliary receiver of the attachment assembly.

8. The firefighting vehicle of claim 1 wherein the base of the attachment assembly
includes a plate constructed and arranged to provide a horizontal platform to support the equipment;
wherein at least a portion of the insert of the attachment assembly is disposed on a first side of the plate; and
wherein at least a portion of the auxiliary receiver is disposed on a second side of the plate that is opposite the first side of the plate.

9. The firefighting vehicle of claim 8 wherein at least a portion of the insert of the attachment assembly is disposed on a top side of the plate; and
wherein at least a portion of the auxiliary receiver is disposed on a bottom side of the plate.

10. The firefighting vehicle of claim 9 wherein the attachment assembly further includes:
a set of gussets coupled with the plate and with the auxiliary receiver, the set of gussets providing strength to support loading perpendicular to the plate and axial loading from the auxiliary receiver.

11. The firefighting vehicle of claim 10 wherein the set of gussets includes:
a left V-shaped gusset welded to the bottom side of the plate and to a left side of the auxiliary receiver, and
a right V-shaped gusset welded to the bottom side of the plate and to a right side of the auxiliary receiver.

12. The firefighting vehicle of claim 1 wherein a back side of the firefighting vehicle body includes a set of hose couplings constructed and arranged to couple with a set of hoses; and
wherein the vehicle receiver is disposed on the back side adjacent to the set of hose couplings.

13. The firefighting vehicle of claim 12 wherein the equipment of the vehicle accessory includes:
a winch device coupled with the base of the attachment assembly, the winch device being constructed and arranged to pull loads from a location adjacent the set of hose couplings when the winch device is attached to the firefighting vehicle body via the attachment assembly.

14. The firefighting vehicle of claim 13 wherein the auxiliary accessory is a hose manager which includes:
a hose manager insert constructed and arranged to engage with the auxiliary receiver, and
an elongated section coupled with the hose manager insert, the elongated section defining a hose deflection surface to manage a set of hoses when the set of hoses couples with the set of hose couplings.

15. The firefighting vehicle of claim 14 wherein the hose manager insert and the insert of the attachment assembly have a common form factor which enables the hose manager insert to engage with the vehicle receiver.

16. The firefighting vehicle of claim 15, further comprising:
a robotically controlled propulsion system coupled with the firefighting vehicle body, and
a set of tracks driven by the robotically controlled propulsion system to form a firefighting robotic vehicle.

17. A vehicle accessory, comprising:
equipment constructed and arranged to operate while attached to a vehicle; and
an attachment assembly constructed and arranged to attach the equipment to the vehicle, the attachment assembly having:
a base constructed and arranged to support the equipment,
an insert coupled with the base, the insert being constructed and arranged to engage with a vehicle receiver of the vehicle, and
an auxiliary receiver coupled with the base, the auxiliary receiver being constructed and arranged to engage with an insert of an auxiliary accessory that is different from the vehicle accessory.

18. The vehicle accessory of claim 17 wherein the equipment includes a winch device coupled with the base of the attachment assembly, the winch device being constructed and arranged to pull loads relative to the vehicle when the winch device is attached to the vehicle via the attachment assembly.

19. The vehicle accessory of claim 18 wherein the base of the attachment assembly includes a plate constructed and arranged to provide a horizontal platform to support the equipment;
wherein at least a portion of the insert of the attachment assembly is disposed on a first side of the plate; and
wherein at least a portion of the auxiliary receiver is disposed on a second side of the plate that is opposite the first side of the plate.
